(19) United States
(12) Patent Application Publication
(10) Pub. No.: US 2019/0240721 A1
(43) Pub. Date: Aug. 8, 2019

(54) Machine and Method of Introducing a Camber into a Length of Wire

(71) Applicant: Kenneth A. Fullick, (US)

(72) Inventors: Thomas S. Kraus, McHenry, IL (US); Kenneth A. Fullick, McHenry, IL (US)

(21) Appl. No.: 15/889,078

(22) Filed: Feb. 5, 2018

(51) Int. Cl. B21F 1/00; B21F 1/02; B21F 11/00; E06B 9/52

(52) U.S. Cl. CPC B21F 1/00; B21F 1/023; B21F 45/00; E06B 9/52; B21F 11/00

(57) ABSTRACT

The present application provides a machine and a method of introducing a camber into a length of wire being conveyed along a path through a machine. As part of introducing the camber, the wire is guided through the machine via at least a first set of rollers and a second set of rollers. The wire being conveyed along the path is diverted via an offset mechanism, which laterally deflects the wire being conveyed away from a straight line route formed between respective wire feed points associated with each of the first and second sets of rollers, wherein the offset mechanism is located between the first set of rollers and the second set of rollers. The diversion in the path of the wire via the offset mechanism introduces the camber having a direction into the wire.

### FIELD OF THE APPLICATION

The present disclosure relates generally to introducing a shape into a length of wire, and more particularly, to a method and a machine of introducing a camber into a length of wire.

### BACKGROUND

The bending of wire for forming a new shape can result from an external force being applied. Whether the material adopts the new shape is dependent upon characteristics of the material being formed. When an external force is applied, the material may transition from deflection (elastic deformation) to deformation (plastic deformation). If the material remains in a state of deflection, when the force is removed, the material will generally return to its pre-deflected state. However, at a certain point during the application of an ever increasing amount of force, the material may transition from a more temporary form of deflection to a more permanent form of deformation. When the applied force reaches a sufficient state of deformation, then the material will often adopt a new shape, such that when the force is removed, the material will generally retain significant characteristics of the newly deformed shape. This is generally the case for wires formed from many types of metals or alloys. Other types of materials may also exhibit a similar response. Such a characteristic allows at least some types of wires to be formed into shapes, which may be deemed to be desirable, while having at least some resistance to further changes in shape from some lesser amounts of subsequently applied forces.

In at least some instances, a deformation can be applied to a wire so as to introduce a camber. A camber refers to a remembered curvature in the structure of the material along its length, which deviates from a straight line. In other words, the wire with a camber will have a rest state with a bow in a desired predetermined direction. In some instances, the camber can be used to better accommodate an anticipated load deflection. The introduced camber will produce a bias toward the introduced curvature, where the application of an external force would either add or subtract to the already existing curvature, against the built in resistance to any change in the remembered shape.

A wire frame can be used with a mesh material to form a screen, which can be used to extend across an opening, such as a window or a door, to limit the unrestricted passing of a material through the opening based upon the size of the holes in the mesh material. For example, a screen may have holes or discontinuities in the mesh material of a size that restricts the traversing of larger objects, such as bugs, birds and larger airborne debris, while providing less restriction to smaller objects, as well as the flow of air.

Wire frames are generally sized to correspond to and have a perimeter, which extends around the outer circumference of the opening. A wire frame will often provide the screen with a structure, that can help a screen hold its shape. When the screen size corresponds closely to the size of the opening, installation of a screen can sometimes be a challenge. Generally, the screen needs to be able to clear any existing structure when being inserted, while also needing to be able to be sized so as to be readily retained within the structure while resisting the forces of any unwanted flow of creatures and/or material through the opening when the screen is installed. However an external force can be applied, which may allow for some shape deviation in the wire frame and correspondingly the screen. Such a shape deviation might better facilitate the insertion/extraction of the screen relative to a preexisting space associated with an opening, such as one or more sets of slots which are adapted for receiving portions of the wire frame of a screen.

At least one type of screen described in Altieri, Jr., U.S. Pat. No. 9,234,388, which is incorporated herein by reference, describes a type of screen that includes a frame made from a material that exhibits a memory as to size and shape, which can be temporarily deflected by compressing the overall shape of the screen by a user when attempting to install and/or remove the screen from an opening, but then the screen fairly readily returns to its original shape, when no longer being handled by the user. In Altieri, Jr., '388, the frame of the screen, when the mesh is secured to the frame, is kept under tension, which biases the frame toward its intended shape, which will generally correspond to the stretched size of the attached mesh material, and often will also be sized and shaped to generally correspond to the size of the opening. However, because the frame is to be maintained by the attached screen material under tension, so as to more readily hold its intended shape, it can be beneficial to incorporate a camber into the wire lengths, which form the sides of the wire frame, and to allow the mesh material to attach to the wire frame, such that the shape of the wireframe is held slightly compressed against the bias of the camber, thereby providing an overall state of tension to the screen whose shape attempts to return to an unbiased state of the wire frame. Generally, the shape of the screen is restricted from returning more fully to the unbiased state of the wire frame by the overall size of the attached mesh material.

Correspondingly, it would be beneficial to allow for a camber to be introduced into a wire material including when the wire material is being formed into a frame for use with a screen to be used in an opening, such as a window opening or a door opening.

### SUMMARY

The present application provides a method of introducing a camber into a length of wire being conveyed along a path through a machine. As part of introducing the camber, the wire is guided through the machine via at least a first set of rollers and a second set of rollers. The wire being conveyed along the path is diverted via an offset mechanism, which laterally deflects the wire being conveyed away from a straight line route formed between respective wire feed points associated with each of the first and second sets of rollers, wherein the offset mechanism is located between the first set of rollers and the second set of rollers. The diversion in the path of the wire via the offset mechanism introduces the camber having a direction into the wire.

In at least some embodiments, the camber includes a remembered bend along each of a plurality of different segments along the length of the wire. In some of these instances, at least some of the plurality of different segments, into each of which a remembered bend is included, are overlapping.

In a further embodiment, the offset mechanism is an offset roller, and when the wire being conveyed along the path is diverted via the offset roller, the wire travels along an outer edge of the offset roller, which rotates with the movement of the wire as the wire is conveyed along the path, and which causes the path of the wire to deviate a distance laterally offset from the straight line route formed between the respective wire feed points associated with each of the first and second sets of rollers.

The present application further provides a machine for introducing a camber into a length of wire being conveyed along a path. The machine includes a first set of rollers and a second set of rollers positioned along the path for guiding the wire through the machine. Each of the first set of rollers and the second set of rollers have a respective feed point through which the wire traveling along the path is conveyed. The machine further includes an offset mechanism located between the first set of rollers and the second set of roller, which diverts the wire being conveyed along the path by laterally deflecting the wire being conveyed away from a straight line route formed between respective wire feed points associated with each of the first and second sets of rollers, thereby introducing a camber into the wire.

These and other features, and advantages of the present disclosure are evident from the following description of one or more preferred embodiments, with reference to the accompanying drawings.

### BRIEF DESCRIPTION OF THE DRAWINGS

FIGS. 1A through 1C are sequential views of a screen and a window during an exemplary installation of the screen into the window;

FIGS. 2A through 2C are individual component and composite views of elements which are included as part of and/or form an exemplary screen;

FIG. 3 is a block diagram of an exemplary machine for forming a wire frame;

FIG. 4 is a partial perspective view of the machine for forming a wire frame highlighting the elements for conveying the wire along a path and introducing a camber into the wire, as the wire is conveyed along the path;

FIG. 5 is a partial perspective view of a wire including an end of the wire;

FIG. 6 is a partial side view of a wire straightener;

FIG. 7 is a partial perspective view of the machine for forming a wire frame highlighting portions associated with a wire bender;

FIG. 8 is a top view of the wire bender portion of the wire frame forming machine;

FIG. 9 is a top view highlighting the shape of the wire both before and after a single bend by the wire bender portion of the wire frame forming machine;

FIG. 10 is a plan view of an exemplary wire after having been shaped into the proximate shape of a frame;

FIG. 11 is a partial expanded view highlighting the ends of the wire after having been formed into the proximate shape of the frame; and

FIG. 12 is a flow diagram of a method for introducing a camber into a wire.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification and is not intended to limit the invention to the specific embodiments illustrated. One skilled in the art will hopefully appreciate that the elements in the drawings are illustrated for simplicity and clarity and have not necessarily been drawn to scale. For example, the dimensions of some of the elements in the drawings may be exaggerated relative to other elements with the intent to help improve understanding of the aspects of the embodiments being illustrated and described.

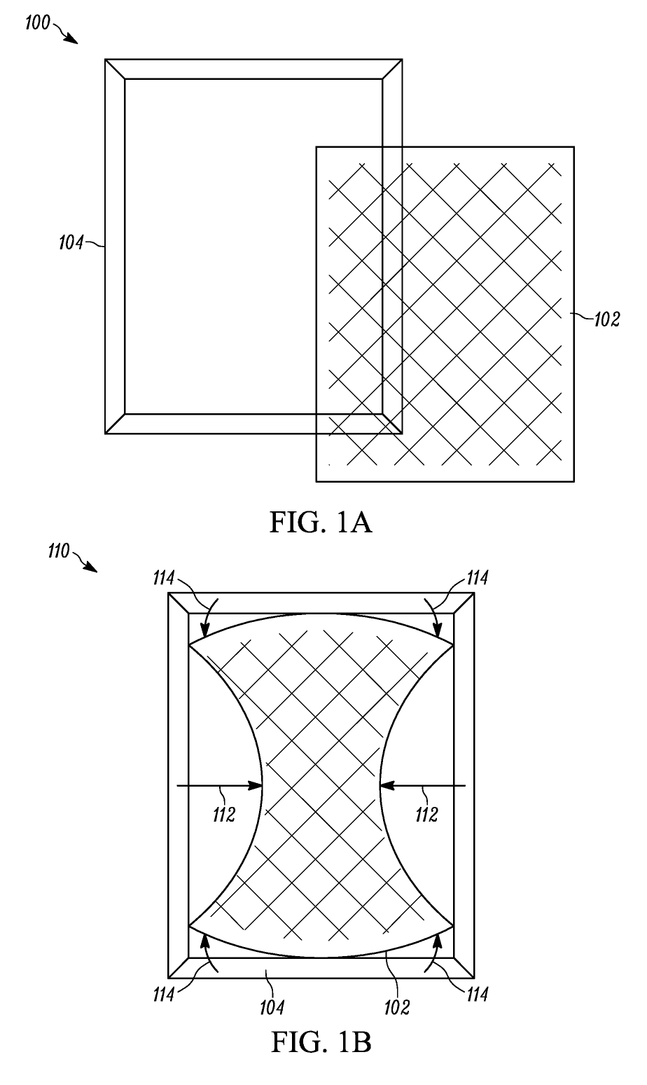

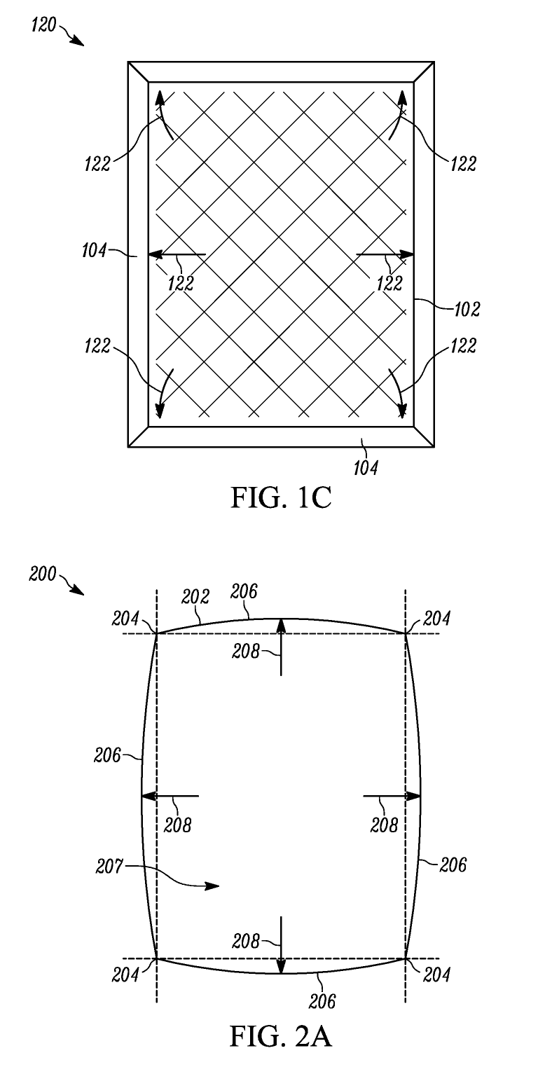

Referring now to the drawings in greater detail, there is illustrated in FIGS. 1A through 1C sequential views of an screen that could incorporate a wire frame, and a window during an exemplary installation of the screen into the window. More specifically, FIG. 1A illustrates a first view 100 in the sequence including a screen 102, which is initially separate from the window 104. As part of insertion of the screen 102 into the window assembly, FIG. 1B illustrates a view 110 of the screen being deformed by a user through a force 112 that is applied to the frame of the screen 102. In the illustrated example, this causes the frame of the screen 102 to flex inward at the sides, which in turn can cause the corners of the screen to also flex 114 inward. This causes the overall shape of the screen to shrink, which makes it easier for the screen to be inserted into the window assembly, so as to cover the opening of the window. When the screen has been received within the window 104, the user can remove the force 112 which has caused the screen 102 to deform. When the force 112 is removed, the frame of the screen 102, which is formed from a material which generally has a memory as to size and shape, will generally attempt to return to its predeformed size and shape. A view 120 of a return to a predeformed size and shape of the screen 102 is illustrated in FIG. 1C, and includes the sides as well as the corners of the frame and correspondingly the screen 102 returning 122 to its unflexed state. In at least some instances, this results in the overall shape of the screen returning to an expanded state, where as part of the expansion, the screen can extend into slots that may be formed in at least some of the sidewalls of the window 104. Expansion into sidewall slots can help to retain the screen 102 within the window 104. Expansion of the frame of the screen can be somewhat limited by the shape of the fabric or screen material that is affixed to the frame.

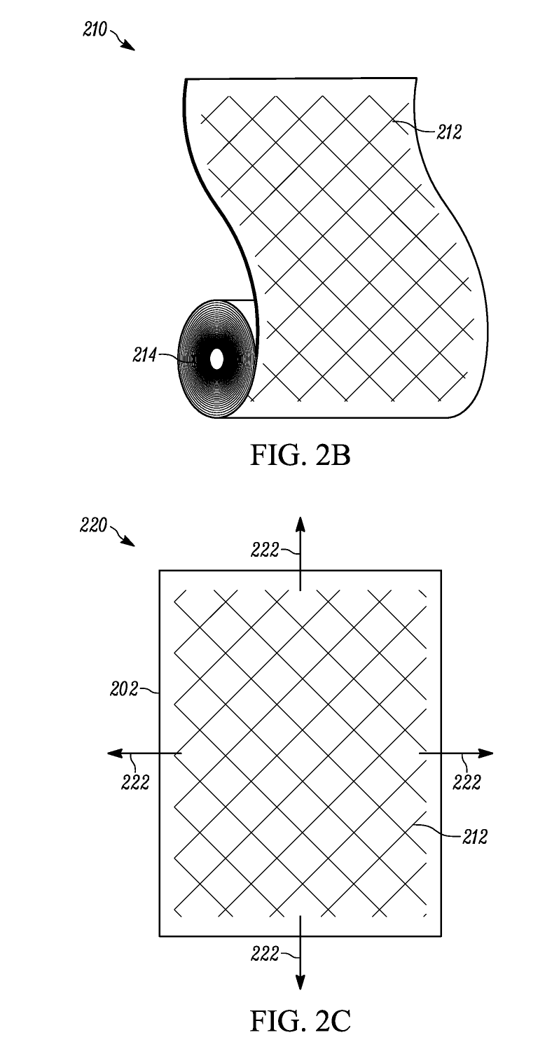

FIGS. 2A through 2C illustrate individual component and composite views of elements which are included as part of and/or form an exemplary screen. More specifically, FIG. 2A illustrates a component view 200 of a frame 202 of a screen prior to the fabric material being affixed thereto. The frame is generally formed from a material, within which a memory as to an undeformed size and shape can be included. In at least some instances, the frame can be formed from steel wire, which has been formed to include one or more corners 204, and having sides 206, where a camber has also been included. In the illustrated embodiment, the frame is generally rectangular in shape, with the ends of the wire being welded together to form a closed loop, where the shape has an outer circumference, which encloses an interior space 207.

In the illustrated embodiment, the installed camber creates a tension in the material, that makes the sides 206 of the frame want to flex 208 outward at least slightly along the length of the sides 206 as the sides extend away from the corners 204. Once formed, the frame can be coated in a material, such as polyvinyl chloride (PVC), that can serve to help resist rusting of the steel wire, as well as supply a layer of material that might attach more readily to a fabric material, such as through a corresponding welding process.

FIG. 2B illustrates a component view 210 of fabric material 212 that can be attached to the frame 202 so as to extend across the interior space 207 of the frame 202 defined by the closed loop of wire material corresponding to an outer edge to which the fabric material 212 might be attached to the frame 202. In at least some instances, the fabric material can be welded to the frame. In other instances, the fabric material may be mechanically fastened to the frame. For example, the fabric material may be sandwiched between two parts of a frame, which when the two parts are brought together, the two parts serve to captivate the fabric material there between, and where relative movement between the fabric material and the joined two parts of the frame is resisted.

In at least some instances, the fabric material 212 will come in rolls 214 from which a portion of the fabric material 212 can be extended. The fabric material 212 is used to cover the frame prior to attaching the fabric material 212 to the frame 202. In at least some instances, prior to attaching the fabric material 212 to the frame 202, the shape of the frame 202 is restricted from bowing outward, so as to more closely correspond to a rectangular shape. However, while the sides of the frame 202 are restricted from bowing outward, during attachment of the fabric material 212, the frame material remembers the camber. After attaching the fabric material 212 to the frame 202, the fabric material 212 serves to limit the sides 206 of the frame from returning from its slightly flexed form, which in turn creates a tension 222 across the fabric material 212 within the frame 202. FIG. 2C illustrates a composite view 220 of an exemplary rectangular frame 202 with fabric material 212 attached.

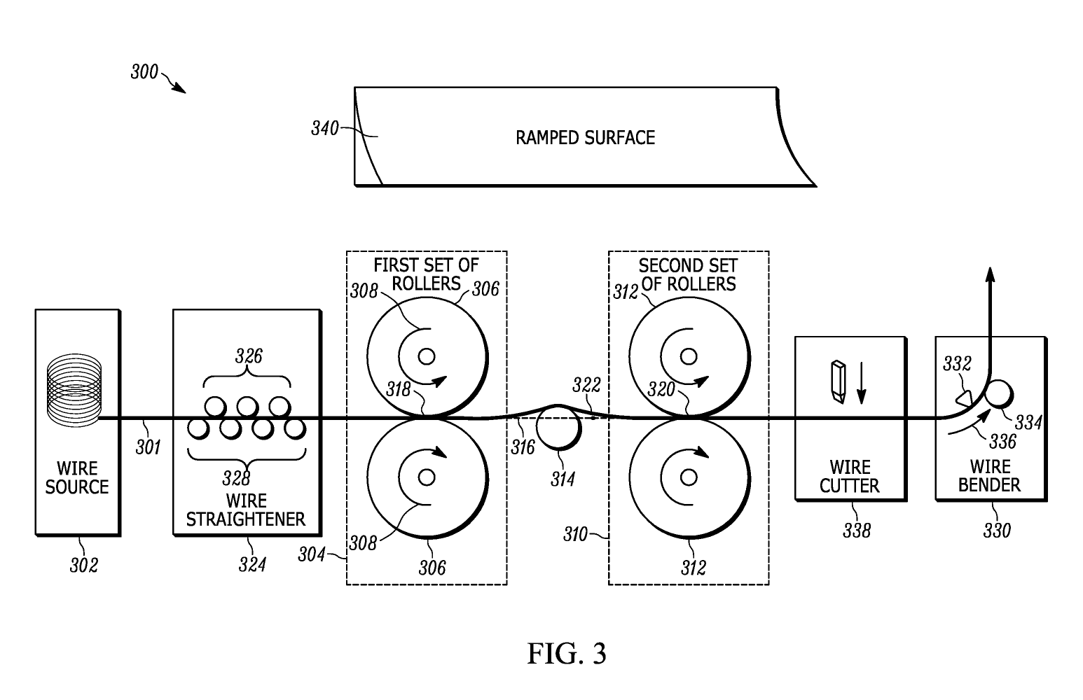

FIG. 3 illustrates a block diagram 300 of an exemplary machine for forming a wire frame. Generally, the exemplary machine acts on wire 301 received from a source 302, in a manner which can cause the characteristics originally present in the wire to be able to be changed. Upon receipt from the source 302, the wire 301 will generally have a remembered shape which defines the twists and turns, if any, along the length of the wire, that the shape of the wire will default to in absence of an external force being applied to the wire 301. In many instances, the machine is intended to act on the wire 301 in such a way that the remembered shape can be adjusted so as to have a more desired set of characteristics. By applying a sufficient deformation force, the remembered characteristics of the wire can be adjusted, so as to conform to a new shape with a new set of characteristics. At least one example of a new shape formed with the wire 301, that may be desirable, includes a wire frame having a wire border, which is sized to extend around the perimeter of an opening, which corresponds to the size of a window or a door.

The wire 301 is pulled from the source 302 by a first set of rollers 304 including at least a pair of rollers. The rollers 306 forming the first set of rollers 304 are spaced so as to allow the wire 301 to move between the at least a pair of rollers. The spacing allows just enough space for the wire to travel between the associated rollers, where each of the rollers 306 engage the passing wire 301 with a sufficient frictional force, so as to be able to pull the wire via the rollers, as the rollers rotate 308. A second set of rollers 310 including at least a pair of rollers 312, which can be similar to the first set of rollers 304, engages the wire 301, and pushes the wire through the rest of the machine. The wire 301 is conveyed through the machine along a path.

The machine further includes an offset mechanism 314, which is located between the first set of rollers 304 and the second set of rollers 310. The offset mechanism 314 is positioned relative to a straight line route 316 between respective feed points 318, 320 associated with each of the first set of rollers 304 and the second set of rollers 310, so as to laterally deflect the path 322 of the wire 301 away from the straight line route 316. The diversion in the path of the wire 301, via the offset mechanism 314, serves to introduce a camber into the wire 301. In at least some instances, the offset mechanism includes an offset roller. In at some of these instances, as the wire is being conveyed along the path, and is diverted via the offset roller, the wire can travel along an outer edge of the offset roller, which rotates with the movement of the wire as the wire is being conveyed along the path. This can cause the path of the wire to deviate a distance, that is laterally offset from the straight line route formed between the respective wire feed points associated with each of the first and second sets of rollers.

In the same or other instances, the offset mechanism can additionally and/or alternatively include an arced tool guide, which can be used to laterally deflect the wire away from a straight line route. Where an arced tool guide is used, it may benefit from some form of lubrication, which will facilitate the passing of the wire along the surfaces of the arced tool guide. In some instances, an arced tool guide may be simpler, may be able to offer a variable radius, and may be more suited for use in smaller spaces, as opposed to relying more exclusively on an offset roller including instances where a thinner or more frail wire and/or instances where a more flexible material is being formed.

In the particular embodiment illustrated, a wire straightener 324 can be positioned along the path of the wire, after the wire source 302 and before the first set of rollers 304. In at least some instances, the wire straightener 324 can include an upper row of spaced apart rollers 326, and a lower row of spaced apart rollers 328. The position of the rollers in the upper row of spaced apart rollers 326 are positioned relative to the rollers in the lower row of spaced apart rollers 328, such that as the wire travels along the path and through the wire straightener 324, a particular point along the length of the wire will alternatively interact with rollers from the upper row 326 and rollers from lower row 328. The alternative interaction is intended to remove any kinks and/or bends in the wire in a direction of displacement between the upper row 326 and the lower row 328 of spaced apart rollers.

The particular embodiment illustrated further includes a wire bender 330 located along the wire path after the second set of rollers 310. The wire bender 330 includes a radius pin 332, and a forming pin 334 that can rotate relative to the radius pin. The wire bender can receive the wire as the wire 301 is conveyed along the path. The forming pin 334 is initially rotated relative to the radius pin 332, so as to enable the received wire to travel between the radius pin 332 and the forming pin 334. When the point along the length of the wire where a bend is desired coincides with a contact surface of the radius pin 332, the forming pin 334 can be rotated, which can cause the wire 301 to be bent at the point along the length of the wire coinciding with the contact point of the radius pin 332. The amount of rotation of the forming pin 334 after engaging the wire 301 can be selected, so as to control the amount of the bend. While the wire 301 is being bent in the wire bender 330 at the desired point along the length of the wire, the overall general conveyance of the wire 301 through the machine is often temporarily interrupted and/or suspended. This enables the wire bender to have the time to introduce the desired degree of bend, while the desired bend point along the length of the wire coincides with the contact point of the radius pin 332. Once the bend is complete, the overall general conveyance of the wire through the machine can be resumed.

A wire cutter 338, which can be positioned along the wire path between the wire bender 330 and the second set of rollers 310, can apply a shearing force that can cause the wire to be cut along the length of the wire at a desired location. Where multiple bends are introduced along the length of the wire 301, it is possible for the wire 301 to double back and potentially interact and/or interfere with elements of the machine located earlier along the wire path. The likelihood of such an interaction may be enhanced in instances, where the overall shape of the wire being formed is intended to be used to form a closed loop, such as where the wire is to be used to form an outer frame of a screen for a window or door opening. A ramped surface 340 is intended to deflect any wire that might be doubling back toward an element of the machine, so as to avoid an unwanted subsequent interaction. In at least some instances, the ramped surface 340 may extend up and over all or parts of the one or more other elements of the machine.

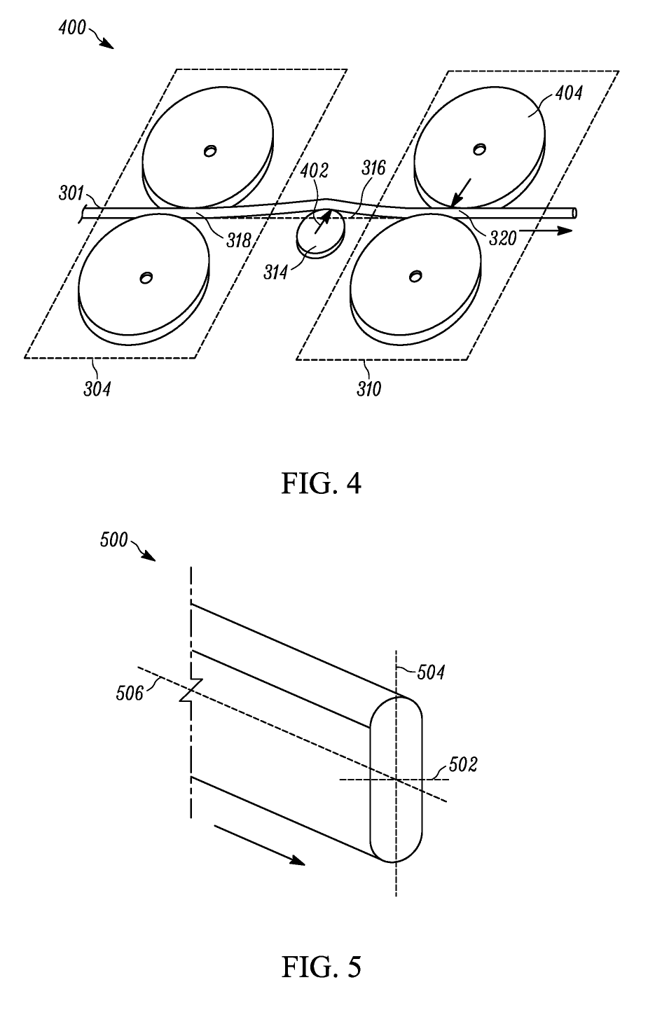

FIG. 4 illustrates a partial perspective view 400 of the machine for forming a wire frame, which highlights the elements for conveying the wire 301 along a path and introducing a camber into the wire, as the wire 301 is conveyed along the path. More specifically, the partial perspective view 400 highlights the first 304 and second 310 sets of rollers, as well as the offset mechanism 314, such as an offset roller. The offset mechanism 314 causes the wire 301 being conveyed along a path to be diverted including being laterally deflected 402 away from a straight line route 316 formed between respective feed points 318, 320 associated with each of the first 304 and second 310 sets of rollers. The lateral deflection causes a local deformation, which introduces a camber into the wire 301. The window of diversion caused by the introduced deviation of the wire path by the offset roller 314 along the length of the wire, within which the local deformation is located, is defined by the portion of wire present between the respective feed points. As the wire moves, the end points of the window of diversion into which a corresponding camber is introduced incrementally changes. This causes a camber to be more uniformly applied to all points along the length of the wire 301, where each corresponding overlapping segment of the wire 301 has an associated amount of bend forming the camber.

In at least some instances corresponding to the particular embodiment illustrated, the offset mechanism 314, such as an offset roller, can behave in a manner similar to a forming pin 334 and the left one 404 of the drive rollers of the second set of rollers 310 can behave in a manner similar to a radius pin 332 of a wire bending interaction at point 406. The slight bending of the wire resulting from the interaction is applied to each point along the length of the wire, as the wire 301 is conveyed along the path past point 406. A resulting camber in the wire 301 is correspondingly introduced, one which is not isolated to a single point, but which is present in each overlapping segment along the length of the wire 301.

FIG. 5 illustrates a partial perspective view 500 of an exemplary wire. The partial perspective view 500 includes a view of the end of the wire, which also corresponds to a cross section of the exemplary wire. Generally, the cross section of the wire will have a width direction 502 and a height direction 504. The wire will also have a direction 506 associated with the length of the wire. As highlighted in the particular example illustrated, the cross section of the wire can have a width which differs from the height. In at least one embodiment, the wire has a cross section having a longer length in the direction 504 of height than the length in a direction 502 of width. However one skilled in the art will recognize that the features of the present application can be applied to wires having varying shapes and sized including varying dimensions associated with the cross section.

In the exemplary embodiment illustrated, each of the respective rollers in each of the first 304 and the second 310 sets of rollers engage the wire on opposite sides along the width 502 of the cross section. The offset mechanism 314 similarly interacts with the wire 301 in a manner which causes a lateral deflection in a direction generally parallel to the width of the wire. Such a combination of interactions could result in a camber being introduced which has a curvature that similarly has a direction generally parallel to the direction of the width 502 of the cross section.

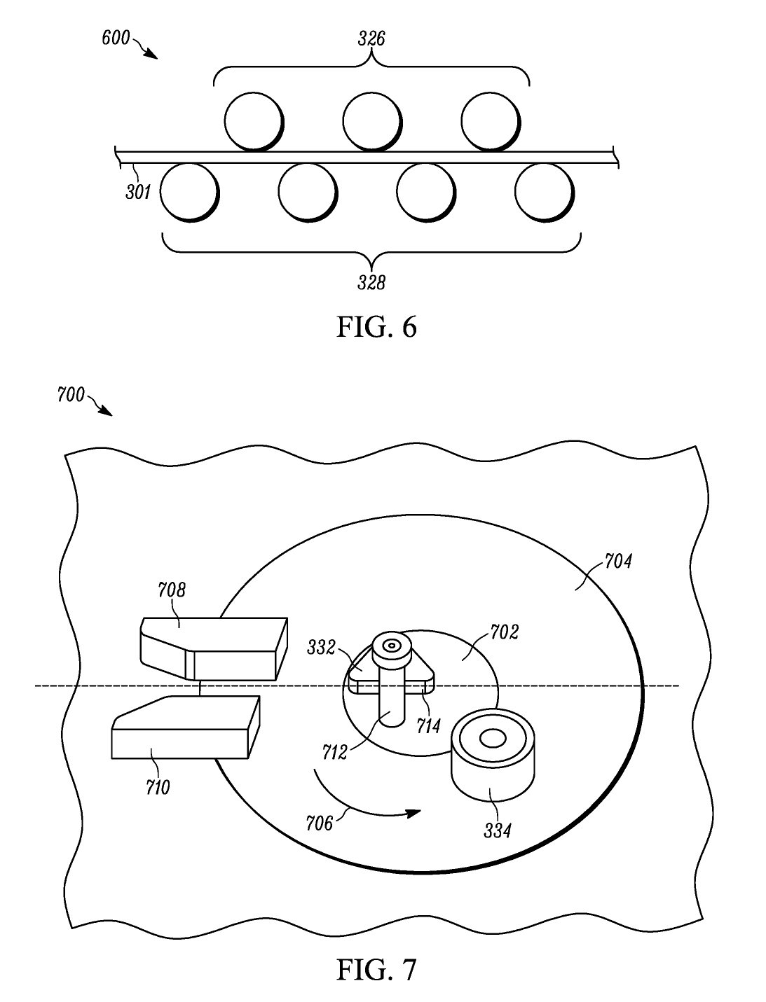

While the rollers associated with first 304 and second 310 sets of rollers, as well as the offset mechanism 314 interact with the wire 301 in a direction 502 generally parallel to the width of the wire, the rollers associated with the wire straightener 324, are arranged to generally interact with the wire 301 in a direction 504 generally parallel to the height of the wire. FIG. 6 illustrates a partial side view 600 of the wire straightener 324. As noted previously, the wire straightener 324 includes an upper row of spaced apart rollers 326, and a lower row of spaced apart rollers 328. In the illustrated embodiment, the upper row includes three spaced apart rollers, and the lower row includes four spaced apart rollers. The upper row of rollers 326 can also have respective points of interaction that are laterally offset relative to the points of interaction associated with the lower row of rollers 328 in a direction generally parallel to length of wire. One skilled in the art will appreciate that the exact number and configuration of rollers could change while still allowing for the intended straightening.

FIG. 7 illustrates a partial perspective view 700 of the machine for forming a wire frame highlighting the elements that are associated with the wire bender 330. The wire bender 330 includes concentric circles 702 and 704, which can correspond to respective cylinders, that rotate 706 relative to one another. More specifically, in the illustrated embodiment, the inner circle 702 is not intended to rotate, while the outer circle 704 which can be associated with a cylindrical ring, is intended to be selectively rotated around the inner circle 702. A radius pin 332 along with a guide pin 712 are coupled to the inner circle 702. A forming pin 334 is coupled to and moves with the outer circle 704.

A wire 301 can be received by the wire bender 330, while the wire 301 is being conveyed along the path. A pair of guiding blocks 708, 710 with chamfered corners guide a received wire 301 along a desired path, toward and between the radius pin 332 and the guide pin 712. In the illustrated embodiment, while the guiding blocks 708, 710 overhang the outer circle 704, the guiding blocks are not attached to the outer circle 704 and do not rotate with the outer circle. As the wire 301 is conveyed along the path, when the wire 301 reaches a point relative to the radius pin 332 where a bend is desired, conveyance along the path may be temporarily interrupted and/or suspended, and the forming pin 334 may be rotated with the outer circle 704, so as to engage the wire 301 and cause the wire to be bent relative to a contact surface 714 of the radius pin 332. In the illustrated embodiment, the contact surface 714 corresponds to a corner of a triangular shaped radius pin 332. The amount of rotation of the outer circle 704/forming pin 334 relative to the inner circle 702/radius pin 332 will affect the amount of bend that is formed in the wire. In at least some instances, relative to the formation of a wire frame, each bend will correspond to an intended corner in the wire frame. A rectangular wire frame can be formed through the inclusion of four approximate ninety degree corners at various predetermined points along the length of the wire. The guiding pin 712 during a bend helps hold the wire 301 relative to the radius pin 332, so as to better control the amount of bend being applied to the wire 301.

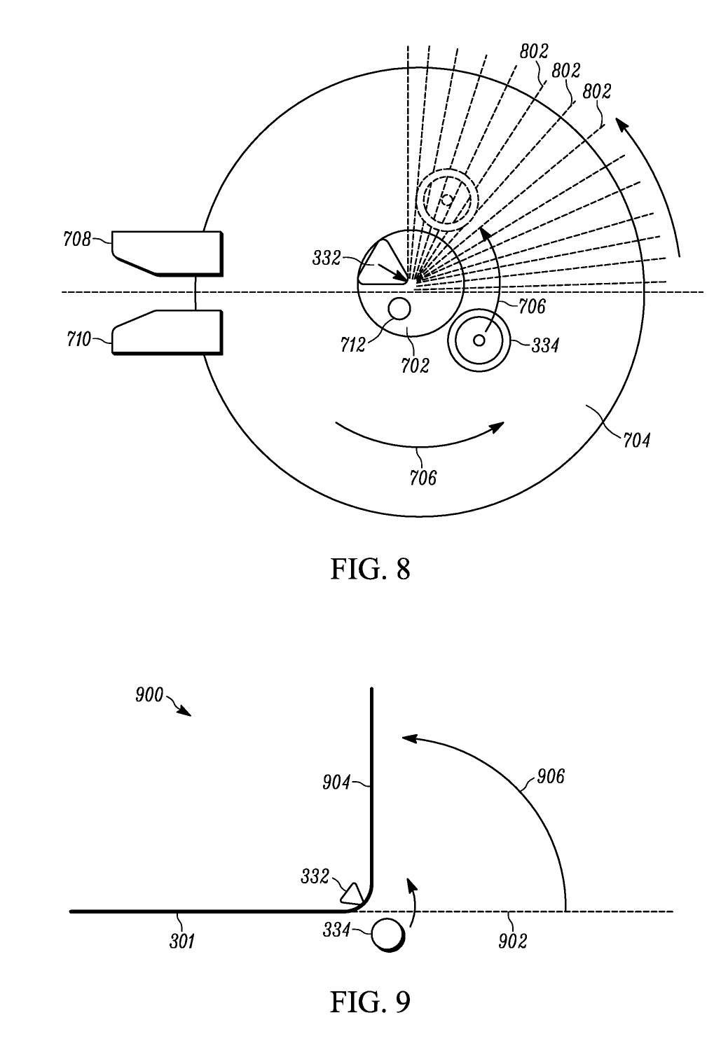

FIG. 8 illustrates a top view 800 of the wire bender 330 portion of the wire frame forming machine. Multiple dashed lines 802 highlight the potential bending of the wire through multiple different degrees of bend positions of a wire 301 as the outer circle 704/forming pin 334 is rotated 706 relative to the inner circle 702/radius pin 332. FIG. 9 illustrates a simplified top view 900 highlighting the shape of the wire 301 both before 902 and after 904 a single bend 906 of the wire 301 by the wire bender 330 portion of the wire frame forming machine.

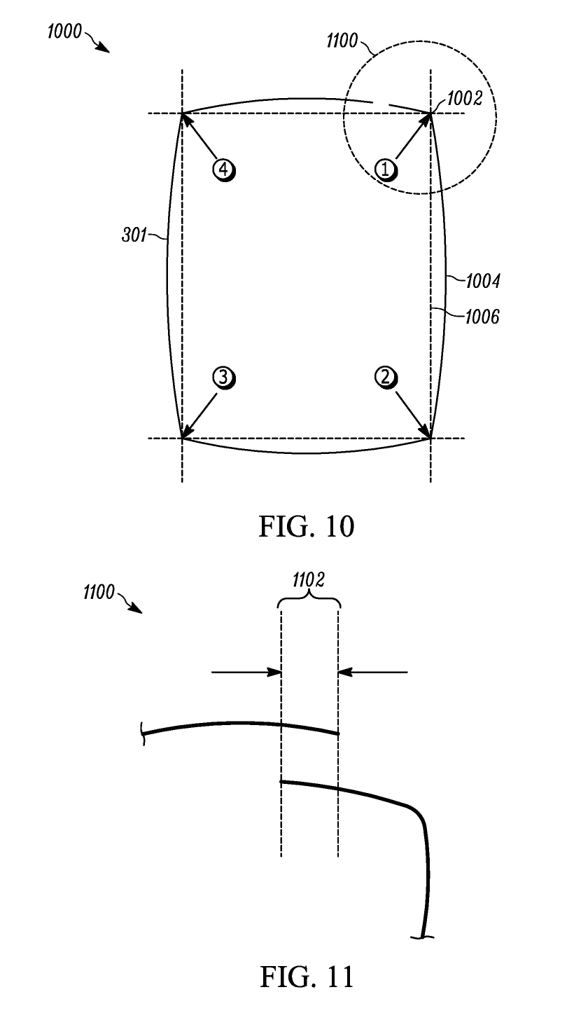

FIG. 10 illustrates a plan view 1000 of an exemplary wire after having been shaped into the proximate shape of a frame. More specifically, the frame is formed into a generally rectangular shape including four corners 1002 and four sides 1004. Each corner 1002 forms an approximate right angle. The sides 1004 are shown as including a slight bend or camber, which causes the sides to be slightly curved relative to the otherwise expected straighter sides 1006 of a rectangle. The four bends forming the corners are shown at different distances along the length of the wire 301. A portion of the length before the first bend and after the fourth bend are intended to form one of the sides. To complete the wire frame, the ends of the wire could be welded together.

FIG. 11 illustrates a partial expanded view 1100 highlighting the ends of the wire after having been formed into the proximate shape of the frame. After being initially formed, prior to the ends being welded together, the ends may have an area of overlap 1102. The excess material associated with the overlap 1102 is material that might be consumed during the process of welding the ends together. Once the ends of the wire 301 are welded together, the resulting formed wire shape could be used as a frame from which a screen for use in the opening of a window or door could be formed.

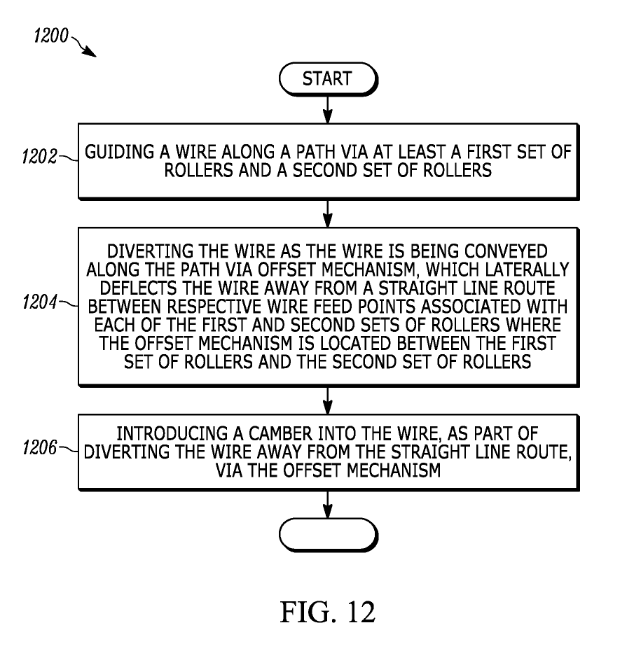

FIG. 12 illustrates a flow diagram 1200 of a method for introducing a camber into a wire. The method includes a wire being guided 1202 along a path through a machine via at least a first set of rollers and a second set of rollers. The wire being conveyed along the path is diverted 1204 via an offset mechanism, which laterally deflects the wire being conveyed away from a straight line route formed between respective wire feed points associated with each of the first and second sets of rollers, where the offset mechanism is located between the first set of rollers and the second set of rollers. A camber is introduced 1206 into the wire as part of diverting the wire away from the straight line route via the offset mechanism.

While the preferred embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of introducing a camber into a length of wire being conveyed along a path through a machine, the method comprising:
guiding the wire through the machine via at least a first set of rollers and a second set of rollers; and
diverting the wire being conveyed along the path via an offset mechanism, which laterally deflects the wire being conveyed away from a straight line route formed between respective wire feed points associated with each of the first and second sets of rollers, wherein the offset mechanism is located between the first set of rollers and the second set of rollers; and
wherein the diversion in the path of the wire via the offset mechanism introduces the camber having a direction into the wire.

2. A method in accordance with claim 1, wherein the camber includes a remembered bend along each of a plurality of different segments along the length of the wire.

3. A method in accordance with claim 2, wherein at least some of the plurality of different segments, into each of which a remembered bend is included, are overlapping.

4. A method in accordance with claim 1, wherein guiding the wire through the machine includes pulling with the first set of rollers the wire from a source.

5. A method in accordance with claim 4, wherein the first set of rollers includes a pair of roller between which the wire is drawn.

6. A method in accordance with claim 1, wherein guiding the wire through the machine includes pushing with the second set of roller.

7. A method in accordance with claim 6, wherein the second set of rollers includes a pair of rollers between which the wire is drawn.

8. A method in accordance with claim 1, wherein when the wire being conveyed along the path is diverted via the offset mechanism, the wire travels along an outer edge of the offset roller, which rotates with the movement of the wire as the wire is conveyed along the path, and which causes the path of the wire to deviate a distance, that is laterally offset from the straight line route formed between the respective wire feed points associated with each of the first and second sets of rollers.

9. A method in accordance with claim 1, wherein as part of guiding the wire through the machine, the wire is pulled through a wire straightener prior to the wire being guided through the first set of rollers.

10. A method in accordance with claim 9, where the wire straightener straightens the wire being guided through the machine in a direction that is substantially perpendicular to the direction that the camber is being introduced into the wire.

11. A method in accordance with claim 1, further comprising bending the wire at one or more points along the length of the wire.

12. A method in accordance with claim 11, wherein a substantially right angle bend is introduced into the wire at each of four points along the length of the wire.

13. A method in accordance with claim 11, wherein the bending of the wire at one or more points includes a bending in a direction similar to the direction of the introduced camber.

14. A method in accordance with claim 11, further comprising deflecting an end of the wire via a ramped surface in instances where the camber and bends introduced into the wire causes the end of the wire which has exited the machine to travel back toward the machine.

15. A method in accordance with claim 1, further comprising cutting the wire at a point along the length of the wire, as the wire travels through the machine.

16. A machine for introducing a camber into a length of wire being conveyed along a path, the machine comprising:
a first set of rollers and a second set of rollers positioned along the path for guiding the wire through the machine, each of the first set of rollers and the second set of rollers having a respective feed point through which the wire traveling along the path is conveyed; and
an offset mechanism located between the first set of rollers and the second set of roller, which diverts the wire being conveyed along the path by laterally deflecting the wire being conveyed away from a straight line route formed between respective wire feed points associated with each of the first and second sets of rollers, thereby introducing a camber into the wire.

17. A machine in accordance with claim 16, further comprising a wire straightener positioned to receive the wire at a point along the path prior to the wire being guided through the first set of rollers.

18. A machine in accordance with claim 16, further comprising a wire bender positioned to receive the wire at a point along the path after the wire has been guided through the second set of rollers.

19. A machine in accordance with claim 18, further comprising one or more ramped surfaces for deflecting an end of the wire in instances where the camber and bends introduced into the wire causes the end of the wire which has exited the machine to travel back toward the machine.

20. A machine in accordance with claim 16, further comprising a wire cutter located along the path for cutting the wire at a point along the length of the wire, as the wire travels through the machine and is conveyed along the path.
